(19) United States
(12) Patent Application Publication
(10) Pub. No.: US 2021/0319996 A1
(43) Pub. Date: Oct. 14, 2021

(54) DEVICE FOR OBTAINING THE MASS OF SINGLE NANOPARTICLES, VIRUSES AND PROTEINS IN SUSPENSION OR IN SOLUTION WITH HIGH-COLLECTION EFFICIENCY

(71) Applicant: Ihsan Dogramaci Bilkent Universitesi, Ankara (TR)

(72) Inventors: Mehmet Selim Hanay, Ankara (TR); Ramazan Tufan Erdogan, Ankara (US); Mohammed Alkhaled, Ankara (TR); Hadi Sedaghat Pisheh, Ankara (TR)

(73) Assignee: Ihsan Dogramaci Bilkent Universitesi, Ankara (TR)

(21) Appl. No.: 17/227,306

(22) Filed: Apr. 10, 2021

Related U.S. Application Data
(60) Provisional application No. 63/007,958, filed on Apr. 10, 2020.
(60) Provisional application No. 63/055,917, filed on Jul. 24, 2020.

(51) Int. Cl. H01J 49/06; H01J 49/10; H01J 49/16; G01N 15/10

(52) U.S. Cl. CPC H01J 49/067; H01J 49/105; H01J 49/165; G01N 2015/0065; G01N 15/10; G01N 2015/1043; H01J 49/164

(57) ABSTRACT

The present invention relates to a device for determining the mass of a nanoparticle, virus or protein in a suspension or solution in a fluid. This device can be applied in particular to mass spectrometry for ionized species with high collection efficiency (i.e. low limit of detection). According to the present invention, an instrument comprises a first device for electrospraying the fluid to obtain a charged flux comprising at least the particle, a second device for determining the mass of the particle by a frequency measurement and a third device that is fabricated on the same chip with, and surrounding the second device to focus and guide the majority of the incoming charged particles including at least the particle by means of holding charge on itself to act as an electrostatic lens. The charge on the third device can be induced either by the original electrospray of the same polarity as the particle itself or by a separate mechanism such as, including but not limited to, by using a separate tip to generate charging through a proper mechanism such as electrospray or corona discharging.

### TECHNICAL FIELD OF THE INVENTION

The present invention relates to a device for determining the mass of a nanoparticle, virus or protein in a suspension or solution in a fluid. This device can be applied in particular to mass spectrometry for ionized species with high collection efficiency (i.e. low limit of detection).

### BACKGROUND OF THE INVENTION (PRIOR ART)

Physical methods to measure the mass of species in the range of 100 kDa to 1000 MDa with single molecule resolution have been reported scarcely in the state of art. Commercial Mass Spectrometry has a cut-off for species heavier than several MegaDalton molecular mass, due to detector limitations. In the last decade, a new approach based on miniature mechanical resonators has been developed to measure the mass of species landing on the resonator. Since this miniature mechanical resonator has taken the form of a Nano-Electromechanical System (NEMS) for the significant demonstrations so far, this approach has been named as NEMS-Mass Spectrometry (NEMS-MS). NEMS-MS has been shown to work successfully on proteins such as Bovine BSA and antibodies such as human IgM.

In NEMS-MS, when the species land on the structure, it increases the effective mass of the resonator, and as a result, the resonance frequency of the resonator shifts down abruptly. By using the resonance frequency shifts, the mass of the species can be determined in one method, by statistically collecting many identical particles. In the study of A. K. Naik et al. [1], the first demonstration of mass spectrometry based on single biological molecule detection with a nanoelectromechanical system has been reported. In that nanoelectromechanical-mass spectrometry system, nanoparticles and protein species are introduced by electrospray injection from the fluid phase in ambient conditions into vacuum, and are subsequently delivered to the nanoelectromechanical system detector by hexapole ion optics.

In another NEMS-MS method, the mass of the particle can be determined by the simultaneous tracking of several mechanical modes, such as the first two flexural mode of a doubly-clamped beam. M. S. Hanay, et al. [2], has demonstrated the first realization of single-molecule NEMS-based mass spectrometry in real time. Herein, as each molecule in the sample adsorbs on the resonator, its mass and position of adsorption are determined by continuously tracking two driven vibrational modes of the device. They have demonstrated the potential of multimode NEMS-based mass spectrometry by analyzing IgM antibody complexes in real time.

In the references cited above, the NEMS detector was placed in an ultra-high vacuum chamber to increase its sensitivity. On the other hand, the species to be analyzed started as solvents in a water-based solution and were then subsequently converted into gas phase ions using Electrospray Ionization (ESI) technique, which is a commonly used technique especially in association with conventional mass spectrometry. Due to the vast difference in the pressures between the Electrospray Ionization condition and NEMS chamber, the aforementioned references employed a differential vacuum system and ion guides to transport the ionic species onto the NEMS chips. Due to the inherent losses in the ion guides, apertures between different differential pressure chambers, and the small cross section of the NEMS detector, the collection efficiency of the species has been very small.

Some methods were developed to increase the detection efficiency of the NEMS devices. In one case, the NEMS detector was placed at a chamber closer, both in terms of pressure and distance, to the Electrospray Ionization source. In the study of O. Malvar, et al. [3], it has been demonstrated that heavier analytes can be identified by their mass and stiffness by using nanomechanical resonators. In this study, they have performed nanomechanical spectrometry of 100 nm-sized gold nanoparticles (GNPs) and Escherichia coli DH5α cells using microcantilever resonators. They have developed theoretical methods that enable the determination of the stiffness, mass and position of the analytes arriving the microcantilever from the resonance frequency jumps. Ignoring the effect of the stiffness leads to an underestimation of the mass of 10% for the used microcantilevers. In this case, less than one particle per 10⁹ particles in solution was detected. To increase the collection efficiency of NEMS detectors, another approach was developed that is based on aerodynamic lensing effect in the patent no. U.S. Pat. No. 9,506,852 B2 which discloses a device for determining the mass of at least one particle in suspension or in solution in a fluid.

In the study of S. Dominguez-Medina, et al. [4], it has been reported that a system architecture combining nebulization of the analytes from solution, their efficient transfer and focusing without relying on electromagnetic fields, and the mass measurements of individual particles using nanomechanical resonator arrays. In this system, only one virus particle detected per 2.6×10⁸ particles in the solution. However, the concentration of virus particles in realistic samples are almost always smaller than 2.6×10⁸ per mL of fluid, with 1 mL being the typical volume sampled from patients. The typical ranges for virus concentration from human samples are between 10³ virus per mL to 10⁶ virus per mL, due to the study of J. D. Spitzberg, et al. [5]. Hence, the collection efficiency of the techniques involving NEMS-MS are not sufficient to be used for screening for viral infection in humans. The aerodynamic lensing approach still creates a focus size on the order of millimeter. To obtain a flux significant enough to work with clinical human samples within a reasonable time, the particle flux needs to be focused much more tightly: in the ideal case, the spot size should match the capture cross section of the NEMS sensor.

Another shortcoming of the previous NEMS-MS approaches, as the technology is applied to virus detection for population screening, is that they require the NEMS detector to operate under high or ultra-high vacuum conditions, which necessitates material and equipment with higher costs. Finally, in current NEMS-MS systems, the NEMS chip is needed to be placed on a micro/nano-positioning system to move the active NEMS sensor to the region where maximum ion flux is delivered. However, this approach both increases the cost of the equipment as well as increases the total analysis time, since for each NEMS device or array introduced, a search procedure should be implemented to find the location of maximum intensity. Clearly, a focusing device that is close to the NEMS detector and fabricated in such a way that the focused particle beam is already aligned with the NEMS detector would form a much more efficient particle collection approach.

### SUMMARY OF THE INVENTION

The present invention relates to a device for determining the mass of single nanoparticles, viruses and proteins in suspension or in solution with high-collection efficiency. The device comprises a first device for creating charged particles of interest in gas phase; a second device for determining the mass of the particle by a frequency measurement comprising at least one gravimetric detector; a third device that is fabricated on the same chip with, and surrounding the second device to focus and guide the majority of the incoming charged particles including at least the particle by means of holding charge on itself to act as an electrostatic lens.

The aim of the present invention is to increase the collection efficiency of NEMS-MS approach such that NEMS-MS can be used in realistic situations, for instance, but not limited to, the detection and mass spectrometric identification of virus particles in a sample obtained from a human.

Another aim of the present invention is to determine the mass of each particle that lands on the subject-matter of device. The collection efficiency is defined as the number of particles arriving at the NEMS detector for analysis over the number of particles originally resided in the sample and subsequently utilized during the process. The collection efficiency is increased for charged analytes by fabricating or placing a sufficiently insulating layer of material near the NEMS detector. Since the focusing layer is already co-fabricated with the NEMS detector, there is no need for a separate alignment procedure for the NEMS and the focusing device. The device subject to the invention, thus makes it possible to determine the mass of each particle that lands on the device, and increases the particle flux received by the second device, owing to the electrostatic focusing effect of the third device.

Another aim of the present invention is to decrease total cost of the system to determine the mass of single nanoparticles, viruses and proteins. According to a particular embodiment, the device is situated in ambient pressure. The advantage of this embodiment is that total cost of the system decreases as there is no vacuum-related equipment.

### BRIEF DESCRIPTION OF THE DRAWINGS

The present invention will be better understood on reading the description of embodiment examples given hereafter, purely as an indication and in no way limiting, and by referring to the appended drawings in which:

FIG. 1 is a schematic view of a particular embodiment of the device, the subject matter of the invention.

FIG. 2 is a schematic view of a particular embodiment of the device, the subject matter of the invention, supplemented with various auxiliary mechanisms to increase the performance of the device.

FIG. 3 is a drawing as an example of the chip surface holding device 2 and device 3.

FIG. 4 is a schematic view of a particular embodiment of the device for determining the mass of single nanoparticles, viruses and viruses in a suspension or solution in a fluid with high collection efficiency.

FIG. 5: is a Scanning Electron Micrograph of a NEMS device fabricated within an empty window on a photoresist layer, wherein the insulating photoresist layer in this case acts as a self-biased electrostatic lens.

FIG. 6: is a top-down view of a Scanning Electron Micrograph of another NEMS device fabricated within an empty window on a photoresist layer, wherein the insulating photoresist layer in this case acts as a self-biased electrostatic lens.

FIG. 7: shows an optical micrograph of a NEMS sensor device fabricated within an electrostatic lensing windows formed by photoresist (In this figure, some particles have already been deposited by electrospray ionization, as a result a halo-like accumulation near the window and blurred features on the NEMS sensor and other places inside the focusing window.).

FIG. 8: shows a Scanning Electron micrograph of a NEMS sensor device fabricated within an electrostatic lensing windows formed by photoresist, wherein individual nanoparticles are discernible in this micrograph and the nanoparticles are gold nanoparticles with a nominal diameter of 20 nm.

FIG. 9: shows a Scanning Electron micrograph of a NEMS sensor device fabricated within an electrostatic lensing windows formed by photoresist, wherein individual nanoparticles are discernible in this micrograph and the nanoparticles are gold nanoparticles with a nominal diameter of 20 nm.

FIG. 10: shows a closed-up view of a Scanning Electron micrograph of a NEMS sensor device fabricated within an electrostatic lensing windows formed by photoresist, wherein individual nanoparticles are clearly visible in this micrograph; and moreover, the lensing effect is seen as the number density of nanoparticles decrease away from the center of the focusing window in the horizontal direction. The nanoparticles are gold nanoparticles with a nominal diameter of 20 nm.

FIG. 11: shows a closed-up view of a Scanning Electron micrograph of the transduction electrode part of the NEMS sensor device fabricated within an electrostatic lensing windows formed by photoresist, wherein individual nanoparticles are clearly visible in this micrograph; and moreover, the lensing effect is seen as the number density of nanoparticles decrease away from the center of the focusing window in the vertical direction, and the nanoparticles are gold nanoparticles with a nominal diameter of 20 nm.

FIG. 12: is the output of the NEMS sensor in the form of frequency change as a function of time, wherein each sudden downward shift indicates the arrival and detection of a single gold nanoparticle.

FIG. 13: shows an optical micrograph of a NEMS sensor device fabricated within an electrostatic lensing windows formed by photoresist, wherein individual nanoparticles and nanoparticle aggregates are discernible in this micrograph and the nanoparticles are polystyrene nanoparticles, incorporating fluorescent dye molecules, and also the nominal diameter for nanoparticles is 100 nm.

FIG. 14: shows two optical micrographs of two similar NEMS sensor devices fabricated within an electrostatic lensing windows formed by photoresist. 100 nm diameter, fluorescent polystyrene nanoparticles are delivered to both chips under identical conditions. The left sensor shows the case where the bonding pads are covered by an insulating material through packaging techniques, whereas the right sensor shows the case of the unpackaged sensor with bonding pads left open. The difference in collection efficiencies show the importance of packaging as any region left open on the surface due to incomplete packaging will decrease lensing efficiency.

### DESCRIPTION OF REFERENCES IN DRAWINGS

The references are presented below:
1. Electrospray ionization source/first device
2. Charges
3. Insulating device/insulating layer
4. Gravimetric detector/second device
5. Substrate
6. Platform
7. Layer
8. Charge-generation source
9. Applied Voltage
10. Sheath gas
11. Drying gas
12. Lens/conductive device
13. Opening
14. Collection of electrodes

### DETAILED DESCRIPTION OF THE INVENTION

The present invention device comprises a first device for creating charged particles of interest in gas phase, a second device for determining the mass of the particle by a frequency measurement comprising at least one gravimetric detector (mass sensor) and a third device that is fabricated on the same chip with, and surrounding the second device to focus and guide the majority of the incoming charged particles including at least the particle by means of holding charge on itself to act as an electrostatic lens. The charge on the third device can be induced either by the original electrospray of the same polarity as the particle itself or by a separate mechanism such as, including but not limited to, by using a separate tip to generate charging through a proper mechanism such as electrospray or corona discharging.

Preferably, the subject-matter of the invention, the device further comprises a separate electrostatic lens in the free space between the first device and the third device for coarse focusing of the charged particles and shielding the second device from the adverse effects of the first device, such as electrical arcing, a gas flow nearly or perfectly parallel with the electrospray direction for further focusing the species, auxiliary gas flows to facilitate the evaporation of charged droplets, a voltage applied to the substrate of the second device either directly or through a printed circuit board to bias the substrate of the second device with respect to the first device.

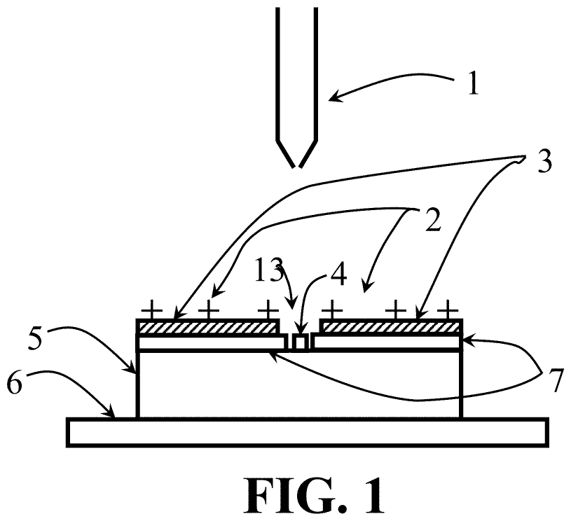

The first device can be any device that ionizes the molecules in the sample to be analyzed without degradation. In other words, the first device is an ionization source. In an embodiment of the invention (FIG. 1), first device is an electrospray ionization source and comprises a capillary tube with a pointed tip, sample solution, high voltage source, fittings required to pass the sample solution through the capillary tube and pumps.

According to a particular embodiment, the device is situated in ambient pressure. The advantage of this embodiment is that total cost of the system decreases as there will be no vacuum-related equipment in the subject-matter of device.

According to a particular embodiment, the first device is situated at ambient pressure, while the second and third devices can be situated in a high-vacuum or ultra-high vacuum chamber. The ion transportation in between the chambers can be accomplished by aerodynamic and ion optics means.

According to a particular embodiment, the first device is an electrospray ionization source with a tip radius small enough to sustain and electrospray into a low-vacuum chamber in which the first device is housed. In this embodiment, the second and third devices are situated in a high-vacuum or ultra-high vacuum chamber. The ion transportation in between can be accomplished by aerodynamic and ion optics means.

According to a particular embodiment, the first device is a source that can operate at high vacuum and ultrahigh vacuum conditions such as Electrohydrodynamic Ionization, MALDI (Matrix Assisted Laser-Desorption Ionization), or LIAD (Laser Induced Acoustic Desorption). In this embodiment, the second and third devices are situated in the same vacuum chamber with the first device.

The second device may be selected from nano-electromechanical systems, micro-electromechanical systems, quartz crystal microbalances, surface acoustic resonators, bulk acoustic resonators, impact detectors, and resonant microwave detectors. It is understood that the output of the second device is a physical signal proportional to the mass of a particle adsorbed on its surface as in the technique of NEMS-MS.

The first device may be selected from Electrospray Ionization, Electrohydrodynamic Ionization, MALDI (Matrix Assisted Laser-Desorption Ionization), LIAD (Laser Induced Acoustic Desorption), ultrasonic nebulizers, microwave induced nebulization devices, microcapillary array nebulizers, surface acoustic wave nebulizers. The first device may be supplemented by an auxiliary technique to introduce additional charges on the droplets such as field emission, or corona discharge.

The third device is an insulating device, preferably in the form of an insulating layer, that surrounds the rest of the chip, leaving the mechanical sensor mentioned in the second device empty. The important feature of this insulating layer is to accumulate electrical charge on it, allowing the sample ions sent by the first device to focus on the mechanical sensor. This insulating layer can be almost on the same level (on) or above (above) the level of the mechanical sensor.

The third device comprises an insulating device 3, preferably in the form of an insulating layer, to hold the incoming charges and an opening 13 on the insulating device 3 aligned with the second device, through which incoming charged ions are focused. The third device may be formed on a layer that is just on the top of the layer that contains the second device and may be out of any sufficiently insulating material, for instance polymers, photoresists, dielectrics such as Silicon Dioxide or Silicon Nitride. The third device has a thickness of 20 nm to 1 mm so that the charged accrued on the third device does not get neutralized quickly: this way electrostatic lensing effect can form.

FIG. 1 is a schematic view of a particular embodiment of the device for determining the mass of single nanoparticles, viruses and proteins in a suspension or solution in a fluid with high collection efficiency. Said device comprises:
a first device 1 for electro-spraying the fluid, to generate charged droplets containing the analyte particles, to obtain a charged flux comprising at least the particle,
accumulated charges, 2, deposited and continuously replenished by device 1, and are held on a third device (insulating layer 3 with an opening 13 aligned with the second device) for obtaining the electrostatic lensing effect.
a second device for determining the mass of the particle by a frequency measurement, said second device comprising at least one gravimetric detector arranged across the electrospray ionization source 1, and is fabricated from a layer 7 which also carries the third device (which acts as an electrostatic lens, comprising insulating layer 3 with opening 13) on it. Obviously, the layer 7 can be composed of a different material than the material of the substrate 5; or it can be made of the same material with the substrate 5 and is an extension of substrate 5 (it is understood that in this case layer 7 is defined by the micro/nanofabrication process). Moreover, the gravimetric detector 4, the layer 7 and the substrate 5, by themselves or a combination may be formed of many different material layers, such as Silicon-on-Insulator, in other words Silicon-Silicon Dioxide-Silicon,
a third device, in the form of an insulating layer 3 for holding the incoming charges, with an opening 13, aligned with the second device, through which incoming charges are focused.

The substrate 5 is part of a chip that holds both the second device and third device. The chip (composed of 5, 4, 7 and preferably insulating layer 3 with opening 13) sits on a platform 6 which provides mechanical support as well as can have the form of a printed circuit board to interface the gravimetric detector 4 to external electronic instruments.

As charges 2 from the electrospray ionization source 1 are accumulated on the insulating layer 3, they create a large electric field towards (for positively charged particles) the opening 13 in the insulating layer 3 which can be implemented by a layer of material with sufficient electrical resistivity, or more specifically the discharging time constant defined by the effective resistance times the effective capacitance to a nearby conductive electrode is long enough so that insulating layer 3 sustains charge on it strong and long enough as to induce electrostatic lensing for incoming particles. The polarity of the charges on 3 should be the same with the polarity of the analyte particles as they are electrosprayed. The incoming analyte particles are deflected by the charges 2 on insulating layer 3 and are focused through the opening 13 to be collected efficiently by the gravimetric device. There may be additional layers deposited in between layer 7 and insulating layer 3 for instance.

The charge accumulation 2 provided by the electrospray ionization source is not necessarily composed entirely by the ions of the analyte particle. Other electrolytes in the solution may also be converted into gas phase ions by the electrospray ionization source, and these ions may also play an instrumental role in sustaining the charge accumulation 2 over the insulating layer 3.

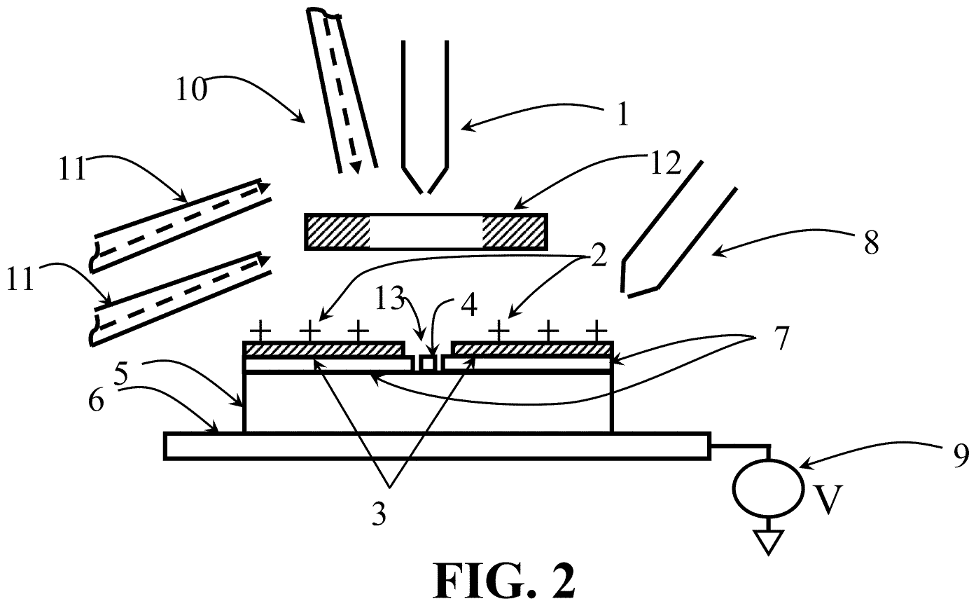

FIG. 2 is a schematic view of a particular embodiment of the device for determining the mass of single nanoparticles, viruses and proteins in a suspension or solution in a fluid with high collection efficiency. Said device comprises:
a device 1 for electrospraying the fluid, to generate charged droplets containing the analyte particles, to obtain a charged flux comprising at least the particle, whereby droplet formation and focusing is facilitated by sheath gas flow 10, either nearly parallel or concentric with the electrospray direction,
a lens 12 that shields the gravimetric detector 4 from the adverse effects of the electrospray ionization source, and may provide additional electrostatic lensing of ions, and is composed of either a single conductor or an array of multiple conductor electrodes, e.g. as in an Einzel lens,
drying gas 11, flows above and/or below the lens 12, to facilitate with the evaporation of the droplets,
charges, 2, deposited and continuously replenished by device 1 and/or device 8, and are held on an insulating layer 3, with an opening 13, for obtaining the electrostatic lensing effect
a gravimetric detector 4 for determining the mass of the particle by a frequency measurement, said second device comprising at least one gravimetric detector arranged across the electrospray ionization source 1 and the opening of the lens 12
a voltage 9 applied at the substrate 5 either directly, or through the carrier platform 6 of the chip.

The substrate 5 is part of the second device that holds both the device 2 and device 3. The microchip sits on a platform 6 which provides mechanical support as well as can have the form of a printed circuit board to interface the gravimetric detector 4 to external electronic instruments.

In this embodiment, the addition of the drying gas 11 increases the rate of evaporation for the charged droplets generated by the electrospray ionization source 1. This way, the desolvated analyte ions can be generated at shorter distances with respect to the electrospray ionization source 1. As a result, the distance between the electrospray ionization source 1 and the gravimetric detection may be decreased for obtaining larger collection efficiencies.

Since gravimetric detectors 4 having enough resolution to measure the mass of nanoparticles and viruses are miniscule, the presence of a nearby electrospray ionization source 1 may cause unwanted effects such as an increase in the noise level, arcing and unintended deposition of large salt crystals or water droplets. The presence of lens 12 is intended to shield the gravimetric detector 4 from such adverse effects. The lens 12 may be placed close to the electrospray ionization source 1 as to avoid clipping particles of interest. Moreover, the lens 12 can form as an additional electrostatic lens connected to a voltage source to focus the ions coarsely on the chip. While the lensing effect of lens 12 can provide millimeter scale spot size, the on-chip lensing third device (insulating layer 3 with an opening 13 aligned with the second device) can provide a focusing spot size on the order of micrometers. Therefore, the lens 12 is seen as an auxiliary mechanism, compared to the critical effect of the third device.

The sheath gas 10 is provided to further focus the electrosprayed microdroplets. The sheath gas 10 can be introduced through a circular and preferably tilted slot concentric with the electrospray ionization source.

A voltage 9 may be applied to the substrate 5 of the chip either directly or through the platform 6 holding the chips, to accelerate and increase the focusing of ions towards the chip (the entire assembly of 5, 7, 4, and preferably 3 with 13), or if desired to decelerate the ions for accomplishing soft landing, in other words the adsorption of material on a surface with minimal chemical and structural changes.

To increase the amount of charging 2 on the insulating layer 3, a charge-generation source 8 different than the original electrospray ionization device 1 may be used. The charge-generation source 8 may be another electrospray ionization source, a corona discharge source, an ionizing radiation source such as a radioactive emitter or soft X-ray source, or any other suitable device. The utility of 8 is that the focusing performance of the third device is decoupled from the dynamics and the composition of the electrospray ionization source 1 process that generates the particles of interest for detection.

While the embodiments in FIG. 2 depict the chip substrate 5 and the support platform 6 as a continuous block of material, another embodiment is envisaged where the substrate 5 and the support platform 6 has a small hole just underneath the gravimetric detector 4, through which a suction is provides to further increase the collection efficiency.

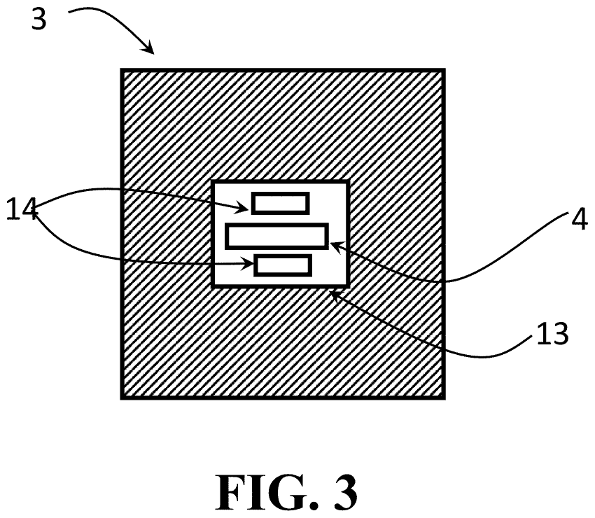

FIG. 3 is a schematic of the top-down view of the chip surface which comprises:
an insulating layer 3 on which the charges/ions are accumulated to generate the focusing effect,
an opening 13 on this insulating layer through which the particles of interest pass and are focused,
a gravimetric detector 4 for determining the mass of the particle by a frequency measurement, said second device comprising at least one gravimetric detector,
a collection of electrodes 14 near the gravimetric detector 4 for further focusing the incoming flux within the opening 13.

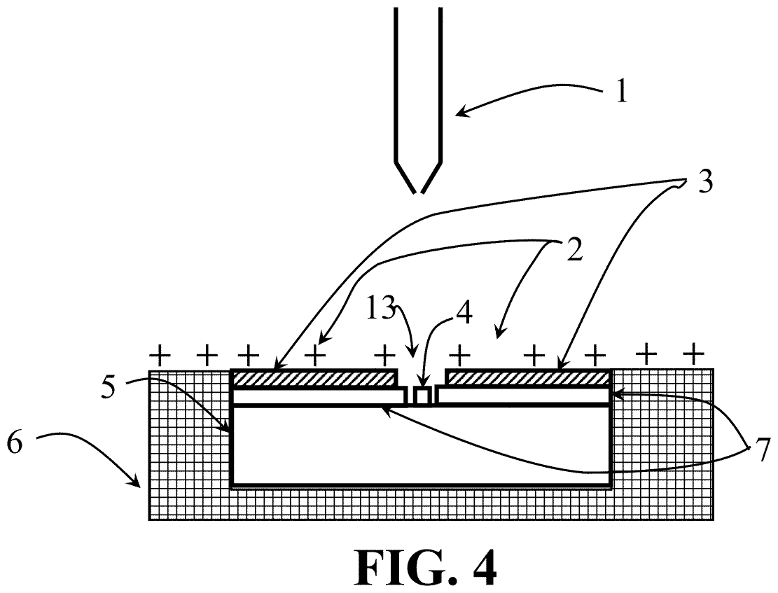

FIG. 4 is a schematic view of a particular embodiment of the device for determining the mass of single nanoparticles, viruses and proteins in a suspension or solution in a fluid with high collection efficiency. Said device comprises:
a first device 1 for electro spraying the fluid, to generate charged droplets containing the analyte particles, to obtain a charged flux comprising at least the particle,
accumulated charges, 2, deposited and continuously replenished by device 1, and are held on both the support platform 6 and an insulating layer 3, with an opening 13, for obtaining the electrostatic lensing effect.
a gravimetric detector 4 for determining the mass of the particle by a frequency measurement, said second device comprising at least one gravimetric detector arranged across the electrospray ionization source 1, and is preferably fabricated from a layer 7 which also carries the insulating layer 3 on it directly or indirectly.

The substrate 5 is part of a chip that holds both the insulating layer 3 with opening 13 and gravimetric detector 4. The chip (composed of 5, 7, 4 and preferably 3 with 13) is situated on a platform 6 with a recess which provides mechanical support as well as can have the form of a printed circuit board to interface the gravimetric detector 4 to external electronic instruments.

In this embodiment of the device, the platform 6 has an insulating top surface and a recessed section into which gravimetric detector 4 can be placed. The advantage of this embodiment is that a smaller chip can be used since the charge accumulation to induce electrostatic charging is performed both by the top surface of the platform 6 and the insulating layer 3. The gap between the platform 6 and the insulating layer 3 may be filled by the application of a suitable, insulating filler material. Obviously, the recessed platform 6 can also be used to replace the platform 6 in the embodiment shown in FIG. 2.

Rapid testing of potential patients before the symptoms appear is still an important problem. It is reported progress towards a microchip-based technology for the detection of SARS-CoV-2 virus at the asymptotic stage. The microchip-based technology is called Nano-Electromechanical Systems (NEMS) and the principle of detection is NEMS-based Mass Spectrometry (NEMS MS).

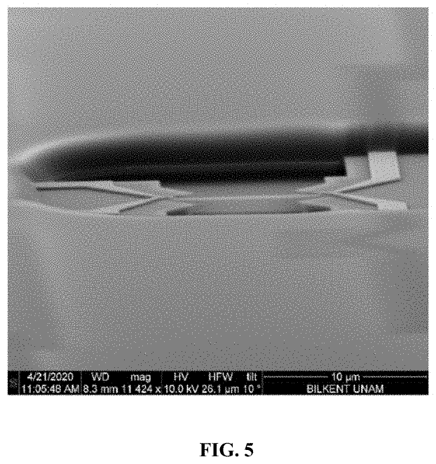

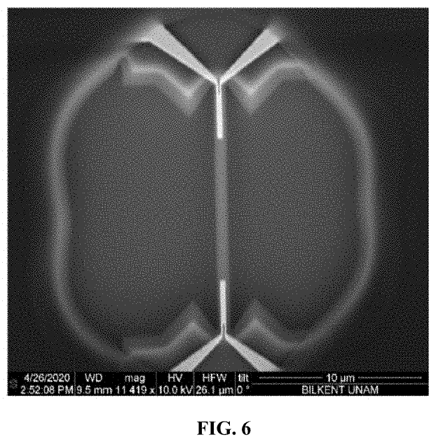

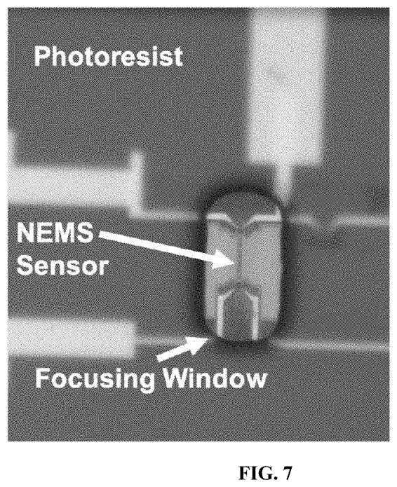

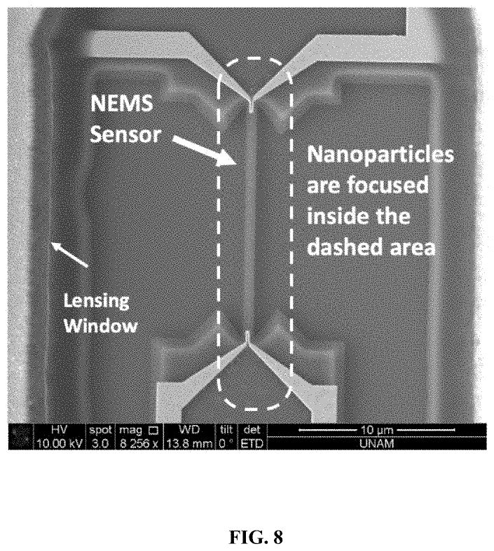

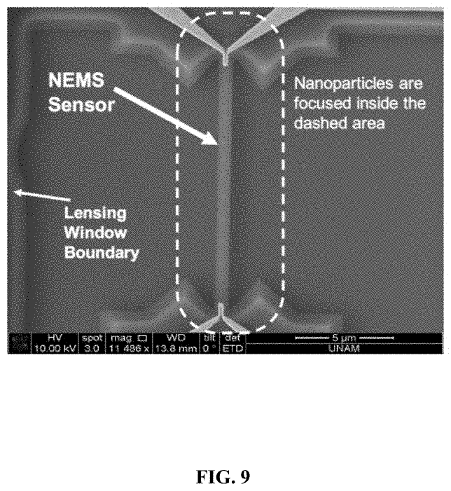

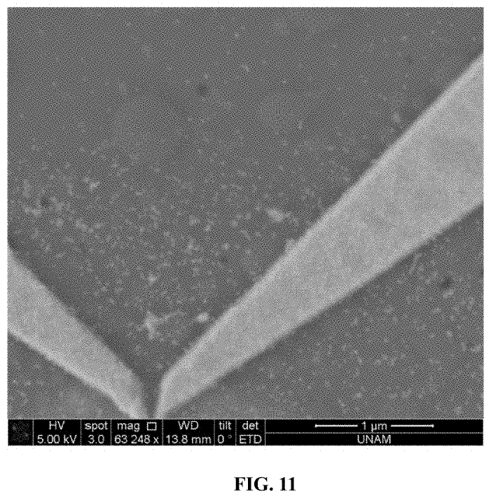

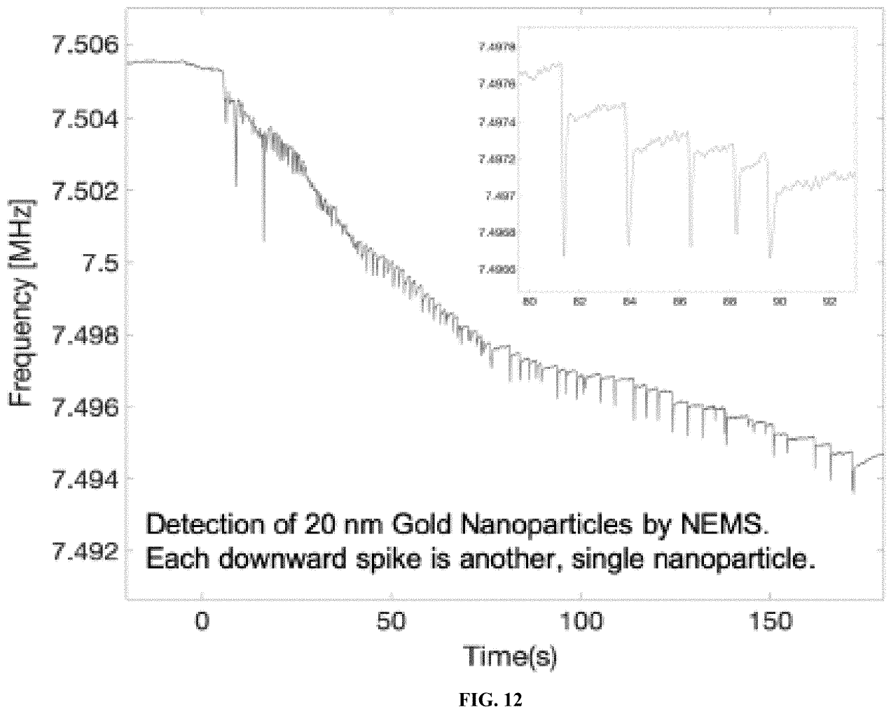

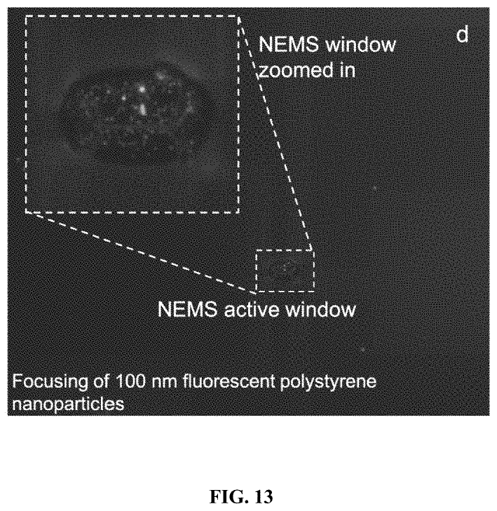

Commercial mass spectrometers cannot directly detect viruses due to their large masses. On the other hand, viruses can easily be detected by the emerging NEMS Mass Spectrometry, with a single-virus resolution. Indeed, during the last decade, it has been already shown that the detection and mass measurement of single biological particles such as BSA (66 kDa), IgM (1 MDa), bacteriophages (˜100 MDa). The real challenge with NEMS Mass Spectrometry is the low capture cross-section due to the small size of the sensor. In the present invention, nanoparticles/viruses are generated in the gas phase by Electrospray Ionization (ESI) and then deposited onto a chip patterned with photoresist (FIG. 5). Since photoresist is an insulator, the regions covered by it will quickly accumulate charge from the analyte ions arriving initially. The charged photoresist will then act as a highly-localized electrostatic lens that will direct the incoming particles to regions without photoresist. When the photoresist (or another suitable insulating material) covers around the NEMS to form a window above the NEMS plane as shown in FIGS. 5 and 6, then the analyte particles can effectively be focused on the NEMS device as shown in FIGS. 7, 8, 9, 10, 11, 12, 13 and 14.

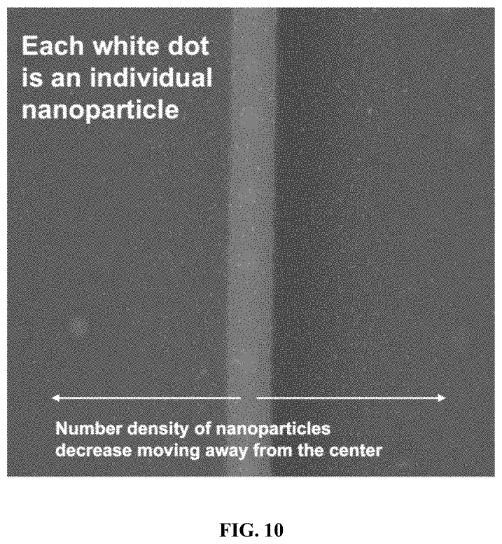

With this “self-lensing” technique, gold and polystyrene nanoparticle have been already delivered onto NEMS with an efficiency better than 1 particle in a million (FIG. 10). By fabricating such “lensing windows” in alignment with the tiny NEMS devices on the chip, the majority of the incoming viruses can be transmitted on the NEMS devices. Parallel use of such insulating, self-biased lenses will provide an increase of throughput for sensing based on NEMS arrays.

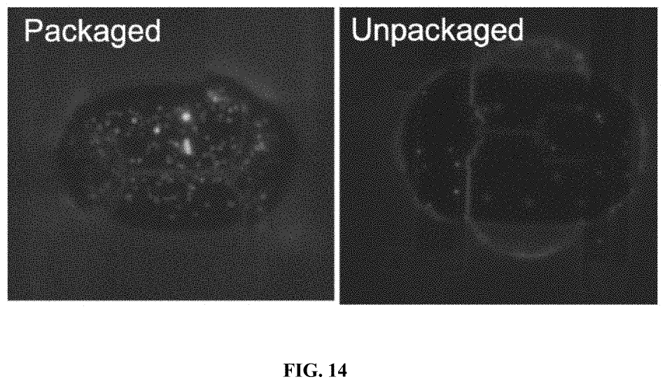

It is proposed that the use of packaging techniques to cover the bonding pads and wirebonds with an insulating material to increase the throughput of the technique by reducing the analyte losses since these metallic surfaces will also act as electrostatic collectors. The difference between a packaged and unpackaged NEMS device of similar size, collecting an equivalent analyte flux is shown in FIG. 14. Clearly packaged devices can collect a larger fraction of the analytes. It is also proposed that the use of backside electrical connections, such as through-silicon-via connections, in conjunction with NEMS sensors to increase the throughput by avoiding front-side wirebonding.

The hydrocarbon chain length in the lipid part of the virion and the number of spike proteins are variable, which will cause a spread in the mass of SARS-CoV-2. For this reason, one of our strategies is to measure and identify via the nucleocapsid part of the virus which has a more specific structure. The nucleocapsid is obtained by treating the entire virion with a low-molecular weight, mild detergent (so as not to disrupt the core, but to dissolve the lipid shell).

After obtaining sample, a centrifugation step for pelleting the cells and mucins will be performed first. Introducing a release agent at this stage will facilitate the dissociation of the virions from the cells. The supernatant—rich with background proteins at this stage—will then be buffer exchanged into 10 mM ammonium acetate, which is the optimal solution for ESI process. The buffer exchange step will be performed by centrifugal filters with 100 kDa molecular weight cutoff, so the majority of the proteins will be separated away from the virus samples. The processed sample will then be used in our NEMS Mass Spectrometer: a large number of hits at the nucleocapsid mass will translate into a positive identification.

It is clear that the proposed invention can similarly be used on processed or natural samples of other viruses, nanoparticles and proteins for the diagnosis of diseases, the characterization of samples e.g. for biomedical screening or pollution monitoring etc.

### REFERENCES

[1] A. K. Naik, et al., “Towards single-molecule nanomechanical mass spectrometry.” Nature Nanotechnology, vol. 4. No. 7, XP 055024639, Jun. 21, 2009, pp. 445-450.
[2] M. S. Hanay, et al., “Single-protein nanomechanical mass spectrometry in real time.” Nature Nanotechnology, vol. 7, Aug. 26, 2012, pp. 602-608.
[3] S. Dominguez-Medina, et al., “Neutral mass spectrometry of virus capsids above 100 megadaltons with nanomechanical resonators.” Science, vol. 362 (6417), Nov. 23, 2018, 918-922
[4] O. Malvar, et al., “Mass and stiffness spectrometry of nanoparticles and whole intact bacteria by multimode nanomechanical resonators.” Nature Communications, vol. 7, Nov. 11, 2016, 13452.
[5] J. D. Spitzberg, et al., “Plasmonic-nanopore biosensors for superior single-molecule detection” Advanced Materials, vol. 31, Apr. 3, 2019, 1900422.

1. A device for determining the mass of single nanoparticles, viruses and proteins in suspension or in solution with high-collection efficiency, characterized by comprising;
a first device for creating charged particles of interest in gas phase, wherein the first device is an ionization source,
a second device for determining the mass of the particle by a frequency measurement comprising at least one gravimetric detector,
a third device that is fabricated on the same chip with, wherein the third device is surrounding the second device to focus and guide the majority of the incoming charged particles on the second device, by accumulating part of the incoming charges on itself to act as an electrostatic lens.

2. A device according to claim 1, characterized by further comprising a separate electrostatic lens in the free space between the first device 1 and the third device for coarse focusing of the charged particles and shielding the second device from the adverse effects of the first device.

3. A device according to claim 1, characterized in that the first device is an electrospray ionization source with a tip radius small enough to sustain and electrospray into a low-vacuum chamber in which the first device is housed.

4. A device according to claim 3, characterized in that the first device is selected from electrospray ionization, electrohydrodynamic ionization, matrix assisted laser-desorption ionization (MALDI), laser induced acoustic desorption (LIAD), ultrasonic nebulizers, microwave induced nebulization devices, microcapillary array nebulizers, surface acoustic wave nebulizers.

5. A device according to claim 3, characterized in that the first device is supplemented by field emission or corona discharge as an auxiliary technique to introduce additional charges on the droplets.

6. A device according to claim 1, characterized in that the second device and the third devices are situated in a high-vacuum or ultra-high vacuum chamber.

7. A device according to claim 1, characterized in that second device is a gravimetric detector which is selected from any of nano-electromechanical systems, micro-electromechanical systems, quartz crystal microbalances, surface acoustic resonators, bulk acoustic resonators, impact detectors or resonant microwave detectors.

8. A device according to claim 1, characterized in that the third device is formed on a layer that is just on the top of the layer that contains the second device.

9. A device according to claim 8, characterized in that the layer is made of any sufficiently insulating material.

10. A device according to claim 9, characterized in that the layer is made of polymers, photoresists, or dielectrics.

11. A device according to claim 10, characterized in that the layer is made of silicon dioxide or silicon nitride.

12. A device according to claim 1, characterized in that the third device has a thickness of 20 nm to 1 mm so that the charges accrued on the third device does not get neutralized quickly.

13. A device for determining the mass of single nanoparticles, viruses and proteins in suspension or in solution with high-collection efficiency, characterized by comprising;
a first device 1 for electro-spraying the fluid, to generate charged droplets containing the analyte particles, to obtain a charged flux comprising at least the particle,
accumulated charges, 2, deposited and continuously replenished by the first device 1, and are held on an insulating layer 3, with an opening 13, for obtaining the electrostatic lensing effect,
a second device for determining the mass of the particle by a frequency measurement, said second device comprising at least one gravimetric detector arranged across the electrospray ionization source 1, and is fabricated from a layer 7 which also carries the third device on it,
a third device wherein an insulating layer 3 that surrounds the rest of the chip

14. A device according to claim 13, characterized in that the layer 7 is composed of a different material than the material of substrate 5 or it made of the same material with substrate 5.

15. A device according to claim 13, characterized in that the gravimetric detector 4, the layer 7 and the substrate 5, by themselves or a combination is formed of many different material layers.

16. A device according to claim 15, characterized in that the gravimetric detector 4, the layer 7 and the substrate 5, by themselves or a combination is formed of silicon-on-insulator.

17. A device according to claim 15, characterized in that silicon-on-insulator is silicon-silicon dioxide-silicon.

18. A device according to claim 13, characterized in that the substrate 5 is part of a chip that holds both the insulating layer 3 with an opening 13 and gravimetric detector 4.

19. A device according to claim 13, characterized in that the chip sits on a platform 6 which provides mechanical support as well as can have the form of a printed circuit board to interface the gravimetric detector 4 to external electronic instruments.

20. A device according to claim 13, characterized in that polarity of the charges on insulating layer 3 should be the same with the polarity of the analyte particles as they are electrosprayed.

21. A device for determining the mass of single nanoparticles, viruses and proteins in suspension or in solution with high-collection efficiency, characterized by comprising;
A first device 1 for electrospraying the fluid, to generate charged droplets containing the analyte particles, to obtain a charged flux comprising at least the particle, whereby droplet formation and focusing is facilitated by sheath gas 10, either flowing nearly parallel or concentric with the electrospray direction,
a lens 12 that shields the gravimetric detector 4 from the adverse effects of the electrospray ionization source, and may provide additional electrostatic lensing of ions, and is composed of either a single conductor or an array of multiple conductor electrodes,
drying gas 11 flows, above and/or below the lens 12, to facilitate with the evaporation of the droplets,
charges 2 deposited and continuously replenished by electrospray ionization source 1 and/or charge-generation source 8, and are held on an insulating layer 3, with an opening 13, for obtaining the electrostatic lensing effect
a gravimetric detector 4 for determining the mass of the particle by a frequency measurement, said second device comprising at least one gravimetric detector arranged across the electrospray ionization source 1 and the opening of the lens 12
a voltage 9 which is applied at the substrate 5 either directly, or through the carrier platform 6 of the chip.

22. A device according to claim 21, characterized in that the substrate 5 is part of the second device that holds both the insulating layer 3 and gravimetric detector 4.

23. A device according to claim 21, characterized in that the microchip sits on a platform 6 which provides mechanical support as well as can have the form of a printed circuit board to interface the gravimetric detector to external electronic instruments.

24. A device according to claim 21, characterized in that the lens 12 is placed close to the electrospray ionization source 1 as to avoid clipping particles of interest.

25. A device according to claim 21, characterized in that the lens 12 can be formed as an additional electrostatic lens connected to a voltage source to focus the ions coarsely on the chip.

26. A device for determining the mass of single nanoparticles, viruses and proteins in suspension or in solution with high-collection efficiency, characterized by comprising;
a first device 1 for electrospraying the fluid, to generate charged droplets containing the analyte particles, to obtain a charged flux comprising at least the particle,
charges, 2, deposited and continuously replenished by the first device 1, and are held on both the support platform 6 and an insulating layer 3, with an opening 13, for obtaining the electrostatic lensing effect.
a device 4 for determining the mass of the particle by a frequency measurement, said second device comprising at least one gravimetric detector arranged across the electrospray ionization source 1, and is fabricated from a layer 7 which also carries the insulating layer 3 on it.

27. A device according to claim 26, characterized in that the substrate 5 is part of a chip that holds both the insulating layer 3 and gravimetric detector 4.

28. A device according to claim 26, characterized in that the chip is situated on a platform with a recess which provides mechanical support as well as can have the form of a printed circuit board to interface the gravimetric detector 4 to external electronic instruments.

29. A device according to claim 26, characterized in that the platform 6 has an insulating top surface and a recessed section into which gravimetric detector 4 can be placed.

30. A device according to claim 26, characterized in that gap between the platform 6 and the insulating layer 3 is filled by an insulating filler material.

31. A device according to claim 1 for use in identification of viruses by identifying the virus mass.

32. A device according to claim 1 for use in identification of viruses by identifying the virus nucleocapsid mass.

33. A device according to claim 1 for use in identification of SARS-CoV-2 virus by identifying the total virus mass.

34. A device according to claim 1 for use in identification of SARS-CoV-2 virus by identifying nucleocapsid mass.

35. A device according to claim 1 for use in identification of proteins by identifying protein mass.

36. A device according to claim 1 for use in identification of nanoparticles by identifying the nanoparticle mass.

37. A device according to claim 1 where the second device is an array of gravimetric sensors, and the third device has multiple openings aligned with the sensors in the array.
